(19) United States
(12) Patent Application Publication
(10) Pub. No.: US 2026/0200541 A1
(43) Pub. Date: Jul. 16, 2026

(54) QUAD ALL WHEEL DRIVE VEHICLE

(71) Applicant: VCARTS, INC., Fulshear, TX (US)

(72) Inventors: N. Alexander Nolte, Fulshear, TX (US); Zhou Hua, Fulshear, TX (US)

(73) Assignee: VCARTS, INC., Fulshear, TX (US)

(21) Appl. No.: 19/386,743

(22) Filed: Nov. 12, 2025

Related U.S. Application Data
(60) Provisional application No. 63/741,405, filed on Jan. 2, 2025.

(51) Int. Cl. B62D 51/02; B60G 15/06; B60K 1/02; B60K 1/04; B60L 15/20; B60L 58/10; B62D 1/16; B62D 51/00

(52) U.S. Cl. CPC B62D 51/02; B60G 15/062; B60K 1/02; B60K 1/04; B60L 15/20; B60L 58/10; B62D 1/16; B62D 51/004; B60L 2240/465; B60L 2250/00

(57) ABSTRACT

Embodiments of the disclosure provide an all-wheel drive all-terrain vehicle that includes a substantially rigid frame member that is elongated and includes a battery compartment and a standing area for a rider positioned above the battery compartment. A rear suspension assembly is positioned at a first elongated end of the frame, the independent rear suspension configured to independently support and allow suspension travel to two separate rear wheels and a front suspension assembly is positioned at a second elongated end of the frame that is opposite the first end of the frame, the front suspension assembly configured to independently support and allow suspension travel to two separate front wheels. The vehicle includes an electric motor positioned in each of the front two wheels and each of the rear two wheels and configured to provide motive force thereto, a a battery positioned in the battery compartment, and a a front wheel electric controller positioned in the battery compartment and in electrical communication with the battery to receive electrical power therefrom and in electrical communication with the electric motors positioned in the front two wheels and configured to selectively provide electrical power thereto along with a separate rear wheel electric controller positioned in the battery compartment and in electrical communication with the battery to receive electrical power therefrom and in electrical communication with the electric motors positioned in the rear two wheels and configured to selectively provide electrical power thereto. A rotatable steering column extends upward from the rigid frame member proximate the front suspension assembly, the steering column having a plurality of operational controls positioned that are positioned above a front portion of the standing area.

### CROSS REFERENCE TO RELATED APPLICATIONS

This application claims priority to and the benefit of U.S. Prov. Pat. App. Ser. No. 63/714,405, which was filed on Jan. 2, 2025, and is hereby incorporated herein by reference in its entirety for all purposes, including the right of priority.

### TECHNICAL FIELD

The present disclosure relates generally to the field of all-terrain vehicles, and specifically to electrically powered all-terrain vehicles and the methods for controlling such.

### BACKGROUND

This section of this document introduces information about and/or from the art that may provide context for or be related to the subject matter described herein and/or claimed below. It provides background information to facilitate a better understanding of the various aspects of the present invention. This is a discussion of “related” art. That such art is related in no way implies that it is also “prior” art. The related art may or may not be prior art. The discussion in this section of this document is to be read in this light, and not as admissions of prior art.

The present disclosure relates to all-terrain vehicles (ATVs), and more particularly, to vehicles such as three wheelers, quads, and dirt bikes. These all-terrain vehicles have traditionally been powered by internal combustion engines, typically two stroke engines, which are known to be powerful, but also very loud and pollution generating. Now, given the advancements of battery technology, motor vehicles have begun to transition away from combustion engines and have transitioned to mass production using electrical motors and on-board rechargeable batteries. The present disclosure extends electric motor and battery technology into the ATV field and provides a novel and unobvious improvement to all existing ATVs.

### SUMMARY

Embodiments of the disclosure provide an all-wheel drive all-terrain vehicle that includes a substantially rigid frame member that is elongated and includes a battery compartment and a standing area for a rider positioned above the battery compartment. A rear suspension assembly is positioned at a first elongated end of the frame, the independent rear suspension configured to independently support and allow suspension travel to two separate rear wheels and a front suspension assembly is positioned at a second elongated end of the frame that is opposite the first end of the frame, the front suspension assembly configured to independently support and allow suspension travel to two separate front wheels. The vehicle includes an electric motor positioned in each of the front two wheels and each of the rear two wheels and configured to provide motive force thereto, a a battery positioned in the battery compartment, and a a front wheel electric controller positioned in the battery compartment and in electrical communication with the battery to receive electrical power therefrom and in electrical communication with the electric motors positioned in the front two wheels and configured to selectively provide electrical power thereto along with a separate rear wheel electric controller positioned in the battery compartment and in electrical communication with the battery to receive electrical power therefrom and in electrical communication with the electric motors positioned in the rear two wheels and configured to selectively provide electrical power thereto. A rotatable steering column extends upward from the rigid frame member proximate the front suspension assembly, the steering column having a plurality of operational controls positioned that are positioned above a front portion of the standing area.

The present disclosure further provides an all-wheel drive all-terrain vehicle that includes an elongated frame having a battery compartment and a rider standing surface positioned above the battery compartment, a rear suspension assembly positioned at a rear portion of the frame and configured to independently support and allow vertical suspension travel to two separate rear wheels while maintaining the two separate rear wheels in a substantially vertical orientation during the suspension travel, and a front suspension assembly positioned at a front portion of the frame opposite the rear portion. The front suspension assembly configured to independently support and allow vertical suspension travel to two separate front wheels while maintaining the two separate front wheels in a substantially vertical orientation during the vertical suspension travel, and allow cooperative pivotal movement of the two separate front wheels to enable steering functions, while maintaining the two separate front wheels in a substantially parallel orientation during the vertical suspension travel. The vehicle further includes an electric motor positioned in each of the front two wheels and each of the rear two wheels and configured to provide motive force thereto, and a battery positioned in the battery compartment, and a front wheel electric controller positioned in the battery compartment and in electrical communication with the battery to receive electrical power therefrom and in electrical communication with the two independent electric motors positioned in the front two wheels and configured to selectively provide electrical power thereto. The vehicle further includes a rear wheel electric controller positioned in the battery compartment and in electrical communication with the battery to receive electrical power therefrom and in electrical communication with the two independent electric motors positioned in the rear two wheels and configured to selectively provide electrical power thereto, and a rotatable steering column extending upward from the front suspension assembly, an upper portion of the steering column having a plurality of operational controls positioned thereon and being positioned above the standing area, while a lower portion of the steering column connects to the two separate front wheels by tie rods to cause the cooperative pivotal movement of the two separate front wheels in a substantially parallel orientation.

The above presents a simplified summary in order to provide a basic understanding of some aspects of what is claimed below. This summary is not an exhaustive overview of the claimed subject matter. It is not intended to identify key or critical elements of the disclosure or to delineate the scope of the claims. Its sole purpose is to present some concepts in a simplified form as a prelude to the more detailed description that is discussed below.

### BRIEF DESCRIPTION OF THE DRAWINGS

The detailed description is made with reference to the accompanying drawings and is provided to assist in a comprehensive understanding of various example embodiments of the present disclosure. Changes may be made in the function and arrangement of elements discussed without departing from the spirit and scope of the disclosure. Various embodiments may omit, substitute, or add various procedures or components as appropriate. For instance, features described with respect to certain embodiments may be combined in other embodiments. In addition, descriptions of well-known functions and constructions may be omitted for clarity and conciseness. Accordingly, those of ordinary skill in the art will recognize that various changes and modifications of the examples described herein can be made without departing from the spirit and scope of the present disclosure.

In the drawings, like reference numbers generally indicate identical, functionally similar, and/or structurally similar elements.

FIG. 1 illustrates a perspective view of an exemplary quad of the present disclosure;

FIG. 2 illustrates a side view of an exemplary quad of the present disclosure;

FIG. 3 illustrates a top view of an exemplary quad of the present disclosure;

FIG. 4 illustrates a more detailed view of the front suspension of an exemplary quad of the present disclosure;

FIG. 5 illustrates a basic schematic view of electrical components of an exemplary quad of the present disclosure;

FIG. 6 illustrates a schematic view of another embodiment of electrical components of an exemplary quad of the present disclosure;

FIG. 7 illustrates the steering mechanism of an exemplary quad of the present disclosure;

FIG. 8 illustrates a top view of the front suspension of an exemplary quad of the present disclosure;

FIG. 9 illustrates a side view of the rear suspension of an exemplary quad of the present disclosure, with the side view taken from the back side of the exemplary quad; and

FIG. 10 illustrates a fully assembled perspective view of an exemplary quad of the disclosure.

While the disclosed subject matter is susceptible to various modifications and alternative forms, the drawings illustrate specific implementations described in detail by way of example. It should be understood, however, that the description herein of specific examples is not intended to limit that which is claimed to the particular forms disclosed, but on the contrary, the intention is to cover all modifications, equivalents, and alternatives falling within the spirit and scope of the appended claims.

### DETAILED DESCRIPTION

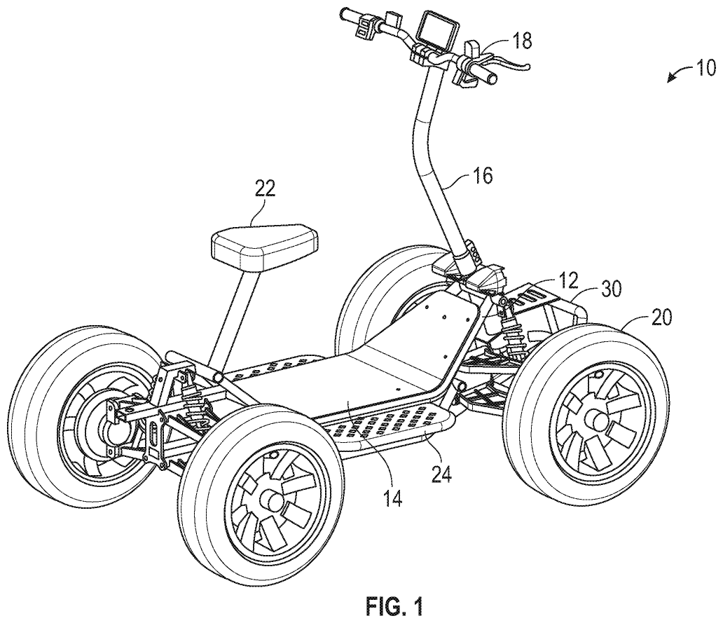

FIG. 1 illustrates a perspective view of an exemplary quad of the present disclosure. The quad of the present disclosure is a four wheeled vehicle designed for all-terrain or off-road use. The quad 10 generally includes four tires 20 that are attached to a frame 12 through a suspension system. The frame 12, which generally has a width that is less than the distance between the inside surface of the tires 20, supports a middle standing area 14 that is between the tires and has a steering column 16 extending generally upward therefrom. The standing area 14 between the tires, meaning the outer edge of the standing area 14 is inside an inner edge of the tires 20 on each side of the quad 10, and the standing area 14 allows a user to stand with their feet on the standing area 14 to operate the quad 10. The steering column may be enclosed or open and generally operates to rotate or pivot along an axis of the steering column 16 to translate steering inputs from the rider of the quad 10 to the steering components in the suspension of the quad 10. The frame 12 may be a rigid material, such as metal tubing, hard plastic material, carbon fiber material, or any combination of metal ad plastics material that provides sufficient strength to operate as a frame for an ATV. The frame 12 is generally configured to support the structure and components of the quad 10. The steering column 16 includes a plurality of controls 18 at an upper end thereof that are used by the rider to control the operation of the quad 10 while generally in a standing or upright sitting position. Again, the rider will be standing on the standing area 14 and then have their hands on the controls 18 to operate the quad 10. Extending in a generally forward direction from the frame 12 on the front side or portion of the quad 10 is a front bumper 30, that may generally extend forward to a point that is behind the front surface of the front tires so that the tires will contact any obstacles before the bumper 30. Extending generally upward from the frame 12 at a rear portion of the quad 10 is a removable single rider seat 22 that is configured to optionally support a rider when operating the quad. The seat 22 may be detached to allow for more movement of a rider that is operating the quad 10 in a standing position. Further, the attachment point for the seat may be used to secure other attachments or accessories, such as a golf bag holder, a gun rack, shooting mount, a cooler holder, a battery operated centrifugal spread feeder, a storage basket or container, a tool box, and any other accessory that may be useful on an ATV.

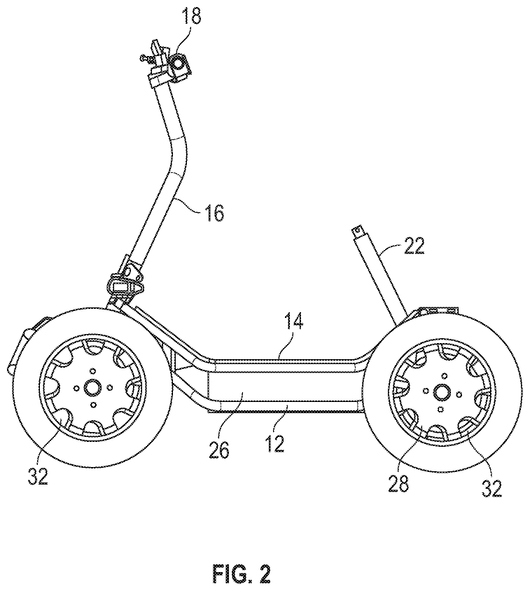

FIG. 2 illustrates a side view of an exemplary quad of the present disclosure. FIG. 2 illustrates a battery enclosure 26 that is essentially surrounded by the frame 12 in a generally middle portion of the quad 10. The battery enclosure 26 may be generally watertight so that fluids cannot enter the battery enclosure 26 and cause electrical short circuits. As will be discussed herein, the battery enclosure 26 may also house or contain electrical components of the quad 10, such as the battery, electrical controllers, the battery management system, voltage/current splitters, battery chargers, and any other electronic components used by the quad 10. The battery enclosure 26 is generally positioned in a space that is surrounded by the rigid frame 12 and therefore protected. The battery enclosure 26 may include extension enclosures (not shown) that extend outward toward the sides of the quad 10 from the sides of the battery enclosure 26, where the battery enclosure 26 side extensions are used to contain additional electric components, such as the motor controller components of the quad. The motor controller components may therefore be positioned in the side extensions that would be positioned below the side steps 24 that extend outward (to the side of the quad) from the frame 12. The side steps 24 extend the middle standing area 14 outward past the frame 12 into the area between the front and rear tires 20 of the quad, thus allowing for a wider and more stable standing platform for the rider, while also providing additional space in the battery compartment 26. This allows for a larger capacity battery to be installed in the quad, thus extending the range of the quad.

Regarding the side steps 24, the outer edge of the side steps extends past the inner edge of the tire 20, but not past the outer edge of the tire 20. The outer edge of the side steps 24 therefore extends to a point between the inner edge and the outer edge of the tire 20 of the quad 10. The positioning of the side steps operates to, among other things, block a large portion of the debris coming from or off of the front tire (mud, rocks, etc.) from traveling upward and hitting the rider of the quad 10. The position of the side steps also provides a substantially wider standing surface 14, which substantially increases the stability of the quad for the rider.

FIG. 2 also illustrates the electric motors 32 that are positioned within each wheel assembly 28 of the four wheels 32 of the quad 10. The wheel assembly 28 may have a central aperture formed therein that allows the power wire for the motor to be connected. The power wire will extend axially outward from the wheel assembly toward the middle of the quad 10 and then connect to the an electric controller for the wheel/motor combination, where the controller is positioned in the battery compartment 26 or in the side compartments extending from the battery compartment under the side steps 24. The electric motors 32 are direct drive motors, meaning they are directly connected to the wheels 32 without any gears, belts, or other loss inducing devices.

The quad 10 may also include the aforementioned side steps 24 that extend outward from battery frame 12 to provide a substantially planar surface for the rider to stand on that essentially increases or extends the middle standing area 14 of the quad 10 outward to the area between the front and rear tires 20 of the quad on both the left side. The side steps 24 also provide some protection to the rider from mud and other objects that come off the tires 20 and travel upward toward the rider. The side steps 24 are positioned in the path of mud and debris that may be slung off the front tires such that the mud and debris will generally hit the bottom of the side steps 24 and be deflected from traveling further upward and hitting the rider of the quad 10. Further, the side steps may be angled upward toward the outside edge to provide a comfortable and safe riding angle, i.e., so the rider's ankle is essentially straight and not bent when standing on the quad 10. The side steps 24 may be angled upward at an angle of about 5 to about 15 degrees or about 7 to 12 degrees.

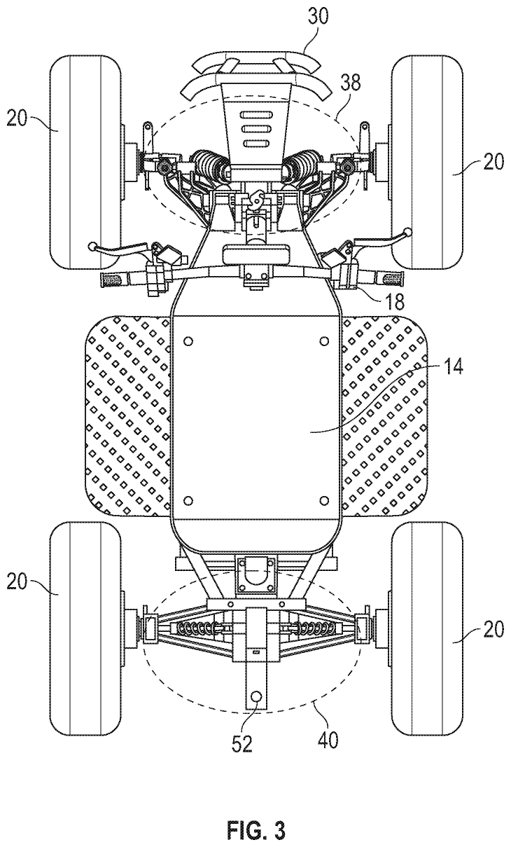

FIG. 3 illustrates a top view of an exemplary quad 10 of the present disclosure. The top view shows the primary standing area 14, which is immediately above the battery enclosure 26 and may serve as the top cover of the battery enclosure 26 that has the battery 34 therein. The primary standing area is positioned inward of the tires 20, meaning the left and right sides of the primary standing area do not extend outward into the area between the tires on either side of the quad 10. The additional standing area provided by the side steps 24, which is not shown in this particular figure, extends outward from the center of the quad on each side of the quad to a position where the outer edge of the side steps 24 is between the tires of the quad. More particularly, the outer edge of the side steps 24 is outward of the inner surface of the tire 20 (the surface closest to the standing surface 14) and is inward of the outer surface of the tire 20 (the side of the tire that is opposite the inner surface).

The battery 34 may be a lithium ion battery capable of being recharged between uses. The top view also generally illustrates the front suspension components 38 and the rear suspension components 40. Both the front and rear suspension components 38, 40 are configured to provide independent suspension travel to each of the four tires 20 on the quad 10. Specifically, the suspension components 38, 40 are configured to allow each of the tires 20 to move upward and downward independently with respect to the other tires 20. The top view also illustrates the trailer hitch assembly 52 that is attached to the frame 12 at the rear of the quad 10, which may be a ball attachment-type hitch that can also be used as a clevis pin attachment hitch or a receiver-type hitch. The trailer hitch 52 allows for a trailer ball to be installed to allow for pulling light duty trailers, or a clevis pin hitch configuration could also be used to pull trailers with the quad 10. The trailer hitch 52 may be a receiver-type hitch.

In another embodiment of the disclosure, the battery 34 may include a first battery 34 positioned in the battery enclosure 26 and a second separate battery positioned in a second location on the quad 10. The second battery may be positioned, for example, in a basket or container positioned near the rear of the quad 10 above and between the rear wheels. The second battery may be in communication with the electrical system of the quad 10 through an isolator switch, which may also be connected to the first or primary battery. In this configuration the isolator switch may be used to switch between batteries for power supply, which enables the user to run one battery capacity down significantly and then switch power supply via the isolator switch to the second battery and resume operation with a full charge or capacity.

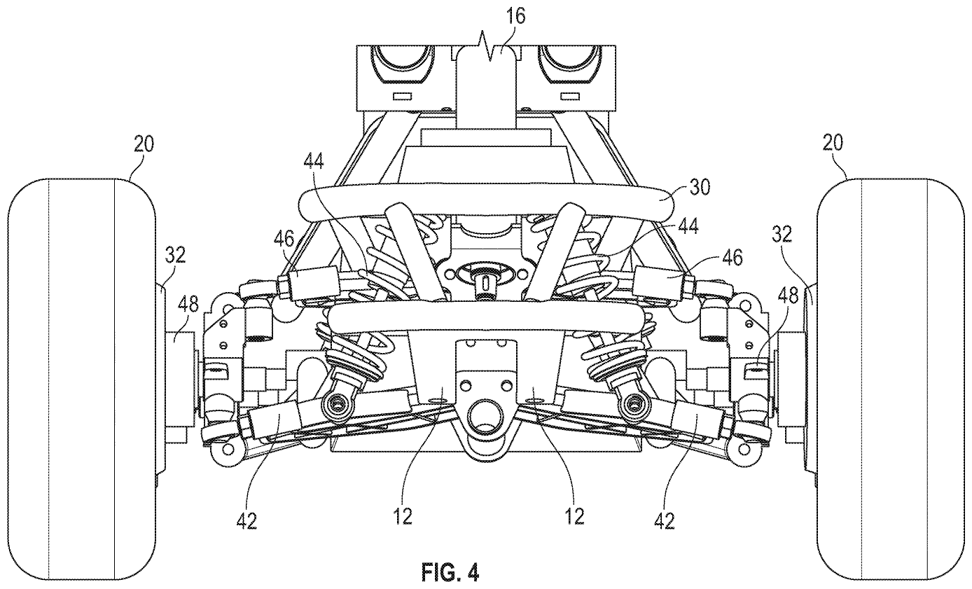

FIG. 4 illustrates a more detailed view of the front suspension 38 of an exemplary quad 10 of the present disclosure. The front suspension 38 generally includes an A-Arm configuration attached to each wheel/tire 28/20 that allows the wheel/tire 28/20 to move upward and downward through the suspension travel. The A-Arms 42 are biased downward by springs and shocks 44 that also operate to both support the weight of the quad and to dampen or absorb energy as the suspension travels upward as the tire 20 hits bumps or obstacles in the terrain it is passing over. The A-Arms 42 attach to the frame 12 inward of the wheels 28 and the A-Arms 42 are positioned parallel to each other and one above the other so that the ends of the A-Arms 42 that are not attached to the frame 12 can be attached to the wheel hub assembly 48, again, one above the other. The positioning of the a-arms 42 attached to the frame 12 one above the other and attached at the other end of the a-arm 42 to the hub assembly 48, again one above the other, provides for the suspension to travel upward and downward (in the same direction as the arms are mounted above each other). The A-arms 42 are positioned such that as the wheel 28 travels upward and downward with suspension movement, the wheel 28 remains in a substantially vertical orientation, which is to say that the camber angle of the wheel remains constant as the suspension travels upward and downward. The spring/shock 44 may also include a shock absorber positioned radially inward of the coil spring 44 to dampen movement of the suspension assembly.

Generally speaking, the quad 10 has a pair of a-arms 42 mounted to the frame 12 near each of the four wheels 28, thus providing each wheel 28 with independent suspension travel capability. Further, since the a-arms 42 mount directly to the frame 12, the suspension provides a stable platform for riding that generally doesn't turn with weight shifts of the rider, rather, the rider must turn the steering wheel or handle bars to rotate the steering column 16, which is connected to the front wheels of the quad 10, to turn the quad in a different direction. More particularly, the suspension configuration of the quad 10 does not turn the wheels 28 when the rider shifts weight from side to side on the quad 10. To the contrary, for increased safety, durability, and overall strength of the quad 10, the rider must turn the steering wheel or handle bars to actuate/rotate the steering column 16 to turn the quad 10.

As further shown in FIG. 4, the lower terminating end of the steering column 16 attaches to tie rods 46 that connect the shaft of the steering column to the wheel hub assemblies 48. Therefore, as the steering column 16 is turned, the tie rods 46 pull/push on the respective hub assemblies 48 of each of the front wheels to turn/pivot the wheels in the same manner as a car to change the direction of the quad 10. Further, the terminating end of the steering column 16 may have a tab 50 extending therefrom, as shown in FIG. 7. The tab 50 may connect to the tie rods 46 to push/pull the wheel assemblies 48 to pivot the wheel assemblies 48 and therefore the tires 20 to steer the quad 10. For example, as the steering column 16 is rotated by the rider, the tab 50 moves in the direction of arrow “A” and the connected tie rods 46 move or pivot the wheel hub assemblies 48 and the tires 20 in the direction of arrow “B” thus providing steering to the quad 10. This unique steering system allows for a fail safe steering system that does not require steering boxes of gears that are prone to failure in ATV environments. The length of tab 50 may be adjusted to change turning radius if needed. Alternatively, a geared steering box may be used.

FIG. 4 illustrates that the A-arms 42 are attached to the frame 12 and allowed to pivot up/down with respect to the frame (generally vertically when the quad is sitting on level ground). The A arms 42 attach to the wheel hub assemblies 48 at an end opposite or distal from the end of the A arm 42 that attaches to the frame. The attachment of the wheel hub assembly 48 to the a-arm 42 is also pivotal, meaning that the wheel assembly 48 may move up/down with terrain, and thus cause the a-arms 42 to move up/down with terrain, while being free to move up/down without substantial frictional restrictions. The hub assemblies 48 on the front of the cart may also be adjustable for camber angle (the tilt of the tire 20 inward/outward from vertical) by a threaded ball joint connector that attaches the wheel hub assembly 40 to the terminating end away from the frame of the a-arm 42. Threading the attaching ball joint inward/outward is used to change/adjust the camber angle of the wheel/tire 28/20 to keep the tires 20 substantially vertical during suspension travel and operation of the quad 10. The threaded ball joint may typically be attached to the lower A-Arm 42 and the lower attachment point of the hub 48. Furthermore, the a-arms 42 may be positioned such that as the wheel assembly 48 travels upward/downward with suspension travel, the camber angle of the tire 20 remains essentially constant at zero degrees (vertical in orientation), which means the tire remains substantially vertical throughout the suspension travel even though the a-arms are pivoting. This is accomplished by aligning the attachment axis of the A-Arms 42 at the frame so that the A-arms, which are essentially the same length and pivot together in similar arcs, which holds the wheel assembly 48 in a vertical position despite the pivoting of the supporting a-arms 42. This suspension configuration provides for improved handling and reduced tire wear of prior art ATVs.

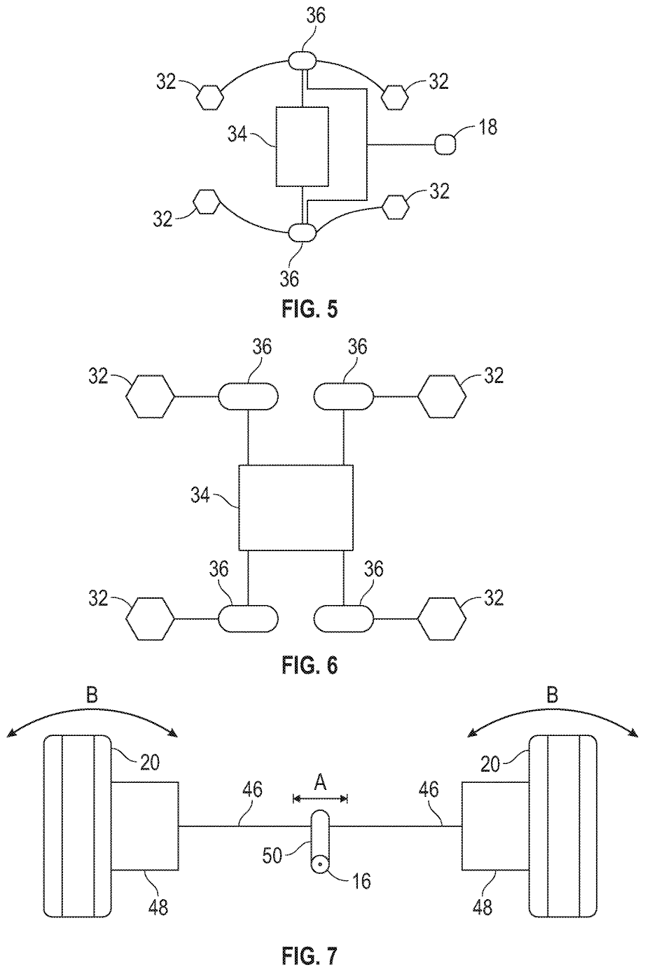

FIG. 5 illustrates a basic schematic view of electrical components of an exemplary quad 10 of the present disclosure. The battery 34 is the electrical energy storage component that provides electrical energy to the system. The battery 34 may be a lithium ion battery or another type of battery that is generally rechargeable and that has the capability to provide electrical power to four electrical motors 32 of the present quad 10. The battery 34 is in electrical communication with an electrical controller 36 that is configured to control the electrical current and/or voltage supplied from the battery 34 to the electric motors 32. The electrical controller 36 is in communication with the controls 18 such that the rider of the quad 10 may control the amount of electrical current or voltage supplied to the motors 32 to control the speed of the quad 10 in operation. Similarly, controls 18 may be used to control the power supplied to each motor 32, thus controlling the torque of the motors 32 to, for example, pull heavy weights or climb steep inclines with the quad 10. The controls 18 may include, for example, a throttle assembly that the rider may actuate to increase or decrease power applied to the motors 32. The throttle assembly may be in electrical communication with the controllers 36 that are configured to receive an electrical signal from the throttle assembly that represents the throttle position of the throttle assembly The controller 36 may then apply electrical power or current to the electric motors 32 in communication with the controller 36, wherein the electrical power applied corresponds to the throttle assembly position selected by the rider of the quad 10. The controls 18 may further include: a speed selector switch that offers varying speed ranges for operation; a torque setting that increases the torque provided by the motors to, for example, enable pulling heavy loads; a direction selector switch that allows the rider to change movement direction of the quad 10; and/or a rotate selector that activates the movement of the quad in a way where the quad can rotate 360 degrees on a central axis to allow for quick turnarounds in tight places.

The rotate selector switch may activate the motor controllers of the quad to rotate the wheels on the right side of the quad in a first direction, while rotating the wheels on the left side of the quad in a second direction that is opposite of the first direction. This opposing wheel rotation will cause the quad to rotate around a central axis that is essentially in the middle of the standing board 14, thus causing the quad 10 to rotate or pivot like a tank, which allows for the rider of the quad to turn around 180 degrees in a minimal width location. This allows the quad to maneuver in much smaller spaces that other quads that can only change direction by steering. The rotate function requires the four controller configuration described below.

The quad 10 of the present disclosure may have a controller 36 that supplies electrical energy to the two motors 32 for the front wheels, while having a separate controller 36 that supplies electrical energy to the two motors 32 for the rear wheels. Recall that each wheel of the quad 10 of the present disclosure may have it's own associated electric motor 32 mounted in the wheel 28 so that each wheel is individually driven without the need for connecting drive shafts, axles, or transfer cases. The motors 32 are mounted integrally with each wheel 28 so there is no interstitially positioned linkage, gears, belts, or other connecting mechanical moving components. The controllers 36 in this configuration may operate cooperatively to control the quad 10 speed in accordance with the inputs from the rider of the quad 10 via the controls 18. Furthermore, the electrical controllers 36 may be selectively activated by the controls 18, such that the rider may select a two-wheel drive option, where the controller 36 for the rear wheels is active and the controller 36 for the front wheels is not active. Thus, the front wheels in this configuration will simply free wheel or roll without resistance, while the back wheels of the quad 10 will provide propulsion. Similarly, the rider may select both controllers 36 to be active such that the quad 10 operates on all wheel drive mode where all four wheels of the quad are operating to provide propulsion to the quad 10. The two wheel drive configuration (using only the rear wheels for propulsion) may be used to prolong battery life when the terrain being traversed is less challenging, i.e. smooth surfaces like roads or level ground.

FIG. 6 illustrates a schematic view of another embodiment of electrical components of an exemplary quad of the present disclosure. The exemplary components of FIG. 6 show a four controller model, wherein each wheel/tire 28, 20 had its own motor 32 and its own independent controller 36. In this exemplary configuration each controller 36 receives electrical power from the battery 34 and supplies electrical power to its associated wheel/tire 28, 20 in accordance with the control inputs from the rider via the controls 18. The four controller configuration provides for additional power to be provided to the electric motors 32 and also allows for the power applied to each wheel to be independently controlled. For example, with the 4 controller model, if one wheel 28 is sensed to be rotating substantially slower than another wheel 28, then the controller associated with the slower wheel 28 may apply additional power to the associated wheel to balance the rotation speed of all 4 wheels. The rotation speed of the wheels may be sensed by the controllers 36 and the controllers may be in communication with each other to share data on wheel speed, power applied, etc. so that wheel speed balancing may be accomplished. This feature may be particularly applicable in low traction situations, such as in mud, where one wheel is spinning freely and another wheel is stuck in mud. The four controller configuration may increase the electrical power provided to the stuck wheel to free the stuck wheel and balance the rotation speed of the four wheels of the quad. The rotation speed of each wheel may be determined by a rotation sensor or by a current sensor for each motor/wheel combination.

In another embodiment of the disclosure, the battery 34, controller 35, and motor 32 configuration may be configured to provide independent motor control to each tire 20. The battery 34 may include a plurality of battery cells that are configured to provide electrical power. Each of the cells may be in communication with a battery management system (BMS) that is configured receive power from the plurality of cells and control the distribution of the battery power to a plurality of battery outputs (typically pairs of positive/negative terminals that provide DC power). The number of battery outputs may be 1-4 in the present disclosure, so the battery may provide 4 independently controlled DC power outlets that may be independently connected to each of the 4 controllers 36 (as shown in FIG. 6). The battery BMS may operate as an electrical current limiter to control the electrical power output of each of the 4 battery outputs. Therefore, the BMS may allow more power to be applied to specific battery output terminals, for example, when a controller 36 requires more power than others due to a challenging terrain.

The controllers may then each independently control the power applied to each of the motors 32. Independent control of current to each wheel provides significant advantages over prior ATV configurations. In low battery situations, for example, the battery may be configured to provide electrical power to only one output terminal, thus energizing only one controller 34 and wheel 32, which may provide an extended range during a low battery situation. Similarly, the controller may be configured to provide more power than normal to one or more controllers in a situation where the controllers require excessive power, such as when the quad is stuck in challenging terrain and one wheel is spinning freely and another wheel is bound up. In this situation applying more power to the stuck wheel may operate to free to quad from the challenging situation, which is a feature that is not provided by any prior art quads.

In another embodiment of the present disclosure, each of the controllers 36 may be configured to be individually controlled to provide for the quad 10 to have a quick or tight rotation turn around function. For example, the rider may push a button on the controls 18 that activates a control sequence where the two left side tires 28 are powered to move in a first direction, while the two right side tires 28 are powered to move in a second direction that is opposite the first direction. Movement of the respective sides of tires in opposite directions causes the quad to rotate on an axis that is essentially in the middle of the standing area 14 of the quad 10 (like a tank). This provides not only a quick 180 degree turn around, but also provides the narrowest possible turn around that can be used to navigate tight spaces. For example, the quick turn function can be used to turn the quad around in a width or turning radius that is essentially the same as the overall length of the quad, thus providing a turning radius that was previous unavailable to any prior art quad.

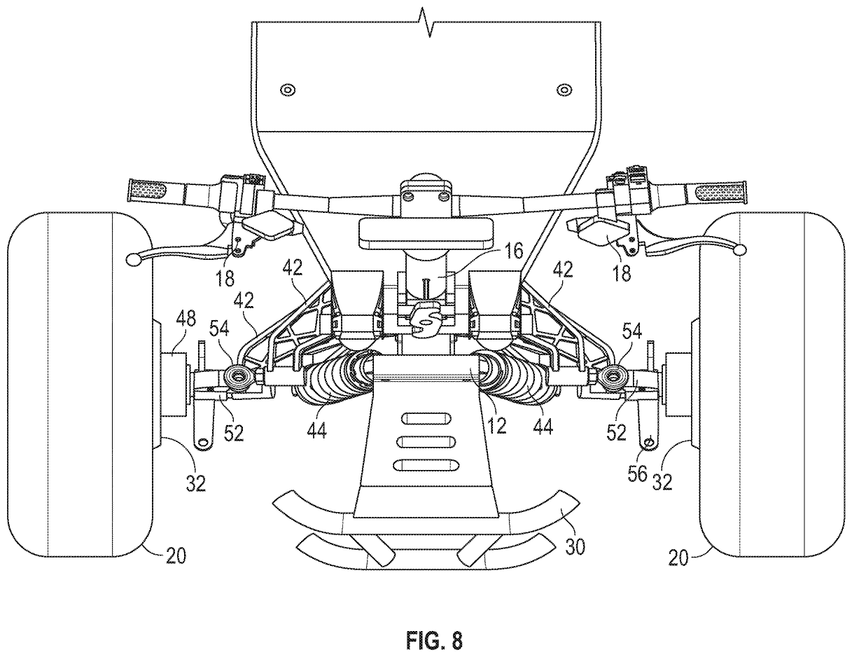

FIG. 7 illustrates a steering mechanism of an exemplary quad of the present disclosure. The steering column 16 connects to a tab 50 that extends radially outward from the column 16 and is configured to pivot through an arc A as the steering column 16 rotates (by user input). The tab 50 is attached at a distal end from the column 16 to the tie rods 46, that then connect on a distal end of the tie rods 46 away from the tab 50 to the wheel hub assembly 48, which includes a pivotally mounted knuckle assembly 52, shown in FIG. 8. The knuckle assembly 52 attaches at a top portion to the top a-arm 42 through a ball joint 54. A second ball joint 54 attaches the lower a-arm 42 to a bottom portion of the knuckle assembly 52. The ball joints 54 allow the hub assembly 48 to pivot about a substantially vertical axis that goes through the center of the ball joints 54, thus allowing the knuckle to pivot and provide steering functionality. The steering function is accomplished by the tie rods 46 attaching to the tie rod hub attachment tab 56 that allows the tie rods 46 to push/pull the knuckle 52 to pivot the knuckle 52 to change the steering position of the wheels 28. The knuckle 52 attaches to the hub 48, which includes the electric motor 32 and a disc brake assembly (not shown), so as the tie rods 46 push/pull on the knuckle 52, the angle of the entire knuckle assembly (including the electric motor 32 and the disc brakes) also changes angle.

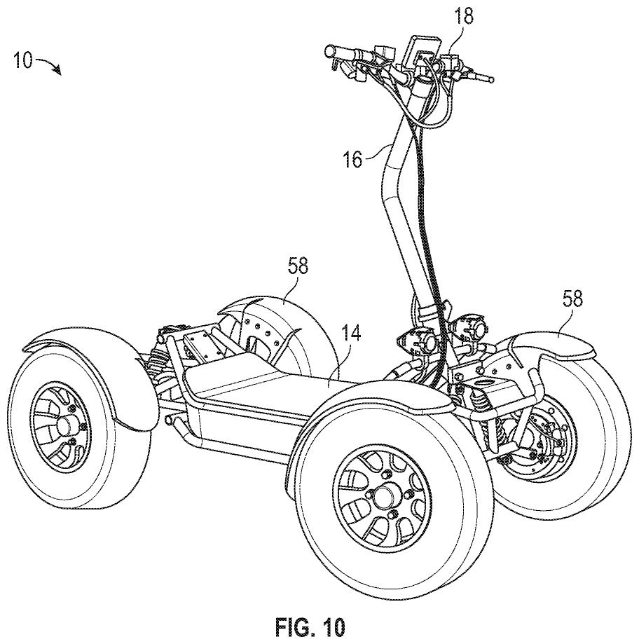

Another feature of the present exemplary quad 10 is that it may include fenders 58 that cover the top portion of the tire 20 and prevent mud and other debris from exiting the tire and hitting the rider of the quad 10, as shown in FIG. 10. The fenders 58 mount or attach to the hub assembly 48 associated with each tire 28 so that the fenders 58 may move up and down with the wheel/tire 28, 20 to stay positioned over the tire 20 in all steering positions and in all suspension positions. The mount for the fender 58 may include a metal frame member that attaches at one end to the fender 58 and at a second end to the hub assembly 48. The frame, in other embodiments, may be attached to the wheel knuckle 52, as the wheel knuckle 52 also pivots by the tie rod 46 movement and will keep the fender 58 positioned above the tire 20 during steering movement. In each of these configurations, the mounting point of the fender 58 may be adjustable to allow the user to select the position of the fender relative to the tire.

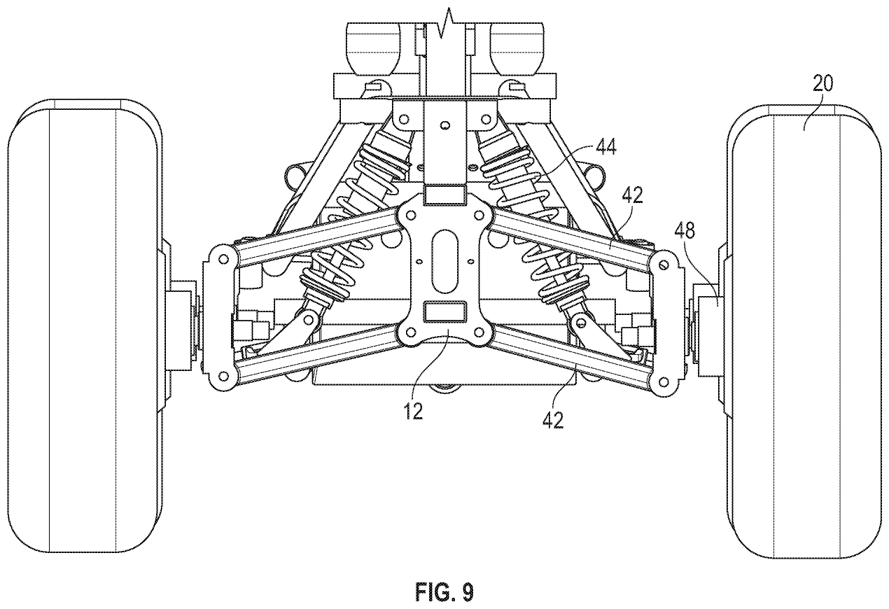

FIG. 9 illustrates a side view of the rear suspension of an exemplary quad 10 of the present disclosure, with the side view taken from the back side of the exemplary quad 10. The rear suspension, which is similar to the front suspension (absent the steering components) includes an upper and lower a-arm 42 on each side of the quad 10. The a-arms 42 attach at a distal end away from the frame 12 attachment points to the wheel hub assembly 48. Further, the mounting points of the upper and lower a-arms 42 to the frame 12 are axial, meaning the attachment points to the frame 12 are in the same vertical axis. Further still, the attachment points for the a-arms 42 to the hub assembly 48 are also in the same vertical axis. This provides for the wheels 12 to move up and down with the suspension travel while keeping the vertical position of the wheel 12 and tire 20 substantially vertical with respect to horizontal. The front suspension uses this same configuration with the upper and lower a-arms 42 mounting to the frame 12 in the same vertical axis to keep the camber angle of the tires 20 constant while the suspension encounters rough terrain. The a-arms mount to the hub through ball joints on the front suspension, but the mounting configuration of the a-arms 42 to the hub 48 is still calculated to have the attachment points to the hub 48 (the ball joints) to be aligned in the same vertical axis in similar fashion to the rear suspension to keep the vertical orientation of the tire constant (camber angle) while the quad 10 is traveling over rough terrain. This is important to handling and tire wear characteristics.

The controls 18 may include a plurality of functions that allow the rider of the quad 10 to vary the operational characteristics of the quad 10. He controls may include brake actuators, such as handles, that apply fluid pressure to brake calipers at each wheel to provide a braking function to the quad 10. The controls 18 may include a handle that actuates the front wheel brakes and a separate handle the actuates the rear wheel brakes, so that the breaking force may be selected an applied individually at the discretion of the rider. The controls 18 may further include a speed selection switch that includes a plurality of predetermined speed settings. For example, the speed setting switch may have settings 1, 2, and 3, wherein setting 1 has a max speed of 10 mph and a max current for acceleration of 100 amps, while setting 2 has a max speed of 20 mph and a max current for acceleration of 125 amps, and while setting 3 has a max speed of 30 mph and a max current for acceleration of 150 amps. These settings, which are communicated to the controllers 36 may be used to both govern operation of the quad 10, but also to select the best operating characteristics for the terrain. The controls may also include a switch that may be used to selectively engage or disengage the motor controller(s) that are associated with the front wheels 28 of the quad 10. The switch may be used to turn off power being applied to the front wheels, thus effectively creating a two-wheel drive quad that uses much less electrical power (due to fewer motors being active). This may be engaged (to disengage the front motors) to extend the range of the quad 10 when the terrain does not require all wheel drive.

In another embodiment of this disclosure, the motors in the respective wheels may be disabled or current limited when the rider actuates one of the brakes. This feature prevent motor overload and excessive unnecessary use of power from the battery. This may be accomplished by having the motor controllers in electrical communication with the electrical wire that activates a brake light on the quad, as when the brake light is active, the brakes are on and the controllers can take this electrical signal as an input command to reduce or suspend power output to the motors until the brakes are no longer being applied.

In another embodiment of the disclosure, the main power wire that connects the motor controller to the electric motor in the wheel hub may be connected through a central aperture in the hub that allows the positive power wire to be connected to the motor and transmitted inward (toward the center of the quad) to exit the hub at a generally central location on the hub. The power wire may then be routed through the suspension components and to the battery enclosure for connection to the motor controller. The aperture in the hub that communicates the wire to therethrough may have a waterproof seal positioned therein to prevent water from ingressing into the motor contained in the hub assembly.

In another embodiment of the disclosure the quad may include a generally horizontal member positioned between the front edge of the side rail between the side rail and the rear edge of the tire on the front of the quad. The horizontal member may extend along the side rail front edge from left to right away from the center of the quad to create the barrier between the side rail and the rotating tire. This horizontal member may be fabricated from a molded plastic or rubber material and may be positioned to fill the bulk of the gap between the side rail and the tire to further block material from traveling upward off the tire toward the rider. Essentially the horizontal member may operate as what is known in vehicles as a mud flap.

In another embodiment of the disclosure, the quad may include a voltage converter configured to supply 12 volt power to components of the quad. Lithium batteries for ATV's and golf carts are typically 48 or 72 volts DC, while essentially all accessories are 12 volts DC. Therefore, the quad of the present disclosure may include a voltage converter or transformer configured to down convert the higher DC battery voltage to a useable 12 volt DC electrical power that may be used to power a plurality of accessories that may be added to the quad, including, for example, audio equipment, additional lights, electric feed spreaders, electrically powered hydraulics, liquid sprayers, electrically powered tools or implements, battery chargers/jump starters, winches, electric coolers, sound bars, and any other 12 volt electrical components that may be used on ATVs, golf carts, side by sides, etc.

In another embodiment of the disclosure the wheel motors may be direct drive motors that have no gears or other mechanical components other than the motor stator and motor rotor. The stator is the stationary part that generates a magnetic field, which on the quad will generally be the central part of the motor that is attached to the hub, while the rotor is the part that rotates within the stator, converting electrical energy into mechanical motion, and the rotor will be the hub part of the quad that rotates around the stator and is attached to the wheel of the quad. One of skill in the art will appreciate that these components may be reversed or switched with minor mechanical modification without departing from the scope of the invention.

In another embodiment of the disclosure, the controls of the quad may include a speed selector. For example, the speed selector may include 3 speed settings (low, medium, and high for example), where each speed setting corresponds to a specific speed range that the quad will operate in. For slower speeds, the rider can select speed setting 1. For faster more aggressive speeds, the rider can select speed setting 2 or 3. In some embodiments of the disclosure the speed settings may be locked so that the rider cannot change the speed settings without a key or other device that may be used to control rider speed, for example, in a rental situation where younger riders need a speed safety switch to control the safe operation of the quad.

In another embodiment of the disclosure, each wheel and tire of the quad may have an associated fender positioned immediately above the tire to block material from slinging off the tire upward. The fender may cover up to the top 40% of the tire, generally beginning near about 2 o clock when looking from the side and continuing over the top of the tire (12 o clock) and continuing rearward to about 9 o clock. This coverage for the fender has shown to block the bulk of the debris coming off the tires. Further, the fenders may be attached to the hub of the quad so that the fenders move up and down with the tire as the suspension travels. This allows the fender to remain at a constant distance from the quad tire through the entire suspension travel. Further still, the fenders may be mounted to the hub of the quad in a slotted manner to allow for the user to adjust the distance the fender is from the tire with a simple wrench operation.

The expressions such as “include” and “may include” which may be used in the present disclosure denote the presence of the disclosed functions, operations, and constituent elements, and do not limit the presence of one or more additional functions, operations, and constituent elements. In the present disclosure, terms such as “include” and/or “have”, may be construed to denote a certain characteristic, number, operation, constituent element, component or a combination thereof, but should not be construed to exclude the existence of or a possibility of the addition of one or more other characteristics, numbers, operations, constituent elements, components or combinations thereof.

As used herein, the article “a” is intended to have its ordinary meaning in the patent arts, namely “one or more.” Herein, the term “about” when applied to a value generally means within the tolerance range of the equipment used to produce the value, or in some examples, means plus or minus 10%, or plus or minus 5%, or plus or minus 1%, unless otherwise expressly specified. Further, herein the term “substantially” as used herein means a majority, or almost all, or all, or an amount with a range of about 51% to about 100%, for example. Moreover, examples herein are intended to be illustrative only and are presented for discussion purposes and not by way of limitation.

As used herein, to “provide” an item means to have possession of and/or control over the item. This may include, for example, forming (or assembling) some or all of the item from its constituent materials and/or, obtaining possession of and/or control over an already-formed item.

Unless otherwise defined, all terms including technical and/or scientific terms used herein have the same meaning as commonly understood by one of ordinary skill in the art to which the present disclosure pertains. In addition, unless otherwise defined, all terms defined in generally used dictionaries may not be overly interpreted. In the preceding, details are set forth to provide a more thorough explanation of the embodiments. However, it will be apparent to those skilled in the art that embodiments may be practiced without these specific details. In other instances, well-known structures and devices are shown in block diagram form or in a schematic view rather than in detail in order to avoid obscuring the embodiments. In addition, features of the different embodiments described hereinafter may be combined with each other, unless specifically noted otherwise. For example, variations or modifications described with respect to one of the embodiments may also be applicable to other embodiments unless noted to the contrary.

Further, equivalent or like elements or elements with equivalent or like functionality are denoted in the preceding description with equivalent or like reference numerals. As the same or functionally equivalent elements are given the same reference numbers in the figures, a repeated description for elements provided with the same reference numbers may be omitted. Hence, descriptions provided for elements having the same or like reference numbers are mutually exchangeable.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In the present disclosure, expressions including ordinal numbers, such as “first”, “second”, and/or the like, may modify various elements. However, such elements are not limited by the above expressions. For example, the above expressions do not limit the sequence and/or importance of the elements. The above expressions are used merely for the purpose of distinguishing an element from the other elements. For example, a first box and a second box indicate different boxes, although both are boxes. For further example, a first element could be termed a second element, and similarly, a second element could also be termed a first element without departing from the scope of the present disclosure.

A sensor refers to a component which converts a physical quantity to be measured to an electric signal, for example, a current signal or a voltage signal. The physical quantity may for example comprise electromagnetic radiation (e.g., photons of infrared or visible light), a magnetic field, an electric field, a pressure, a force, a temperature, a current, or a voltage, but is not limited thereto.

Use of the phrases “capable of,” “capable to,” “operable to,” “configured to,” or “programmed to” in one or more embodiments, refers to some apparatus, logic, hardware, and/or element designed in such a way to enable the use of the apparatus, logic, hardware, and/or element in a specified manner. Use of the phrase “exceed” in one or more embodiments, indicates that a measured value could be higher than a pre-determined threshold (e.g., an upper threshold), or lower than a pre-determined threshold (e.g., a lower threshold). When a pre-determined threshold range (defined by an upper threshold and a lower threshold) is used, the use of the phrase “exceed” in one or more embodiments could also indicate a measured value is outside the pre-determined threshold range (e.g., higher than the upper threshold or lower than the lower threshold). The subject matter of the present disclosure is provided as examples of apparatus, systems, methods, circuits, and programs for performing the features described in the present disclosure. However, further features or variations are contemplated in addition to the features described above. It is contemplated that the implementation of the components and functions of the present disclosure can be done with any newly arising technology that may replace any of the above-implemented technologies.

Various modifications to the disclosure will be readily apparent to those skilled in the art, and the generic principles defined herein may be applied to other variations without departing from the spirit or scope of the present disclosure. Throughout the present disclosure the terms “example,” “examples,” or “exemplary” indicate examples or instances and do not imply or require any preference for the noted examples. Thus, the present disclosure is not to be limited to the examples and designs described herein but is to be accorded the widest scope consistent with the principles and novel features disclosed.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. An all-wheel drive all-terrain vehicle, comprising:
an elongated frame having a battery compartment and a rider standing surface positioned above the battery compartment and between two outer frame rails;
a rear suspension assembly positioned at a rear portion of the frame and configured to independently support and allow vertical suspension travel to two separate rear wheels while maintaining the two separate rear wheels in a substantially vertical orientation during the vertical suspension travel;
a front suspension assembly positioned at a front portion of the frame opposite the rear portion, the front suspension assembly configured to:
independently support and allow vertical suspension travel to two separate front wheels while maintaining the two separate front wheels in a substantially vertical orientation during the vertical suspension travel; and
allow cooperative pivotal movement of the two separate front wheels about a vertical axis for each wheel to enable steering functions, while maintaining the two separate front wheels in a substantially parallel orientation during the vertical suspension travel and maintaining the two front wheels in a substantially vertical orientation;
a battery positioned in the battery compartment;
four electric wheel motor controllers positioned in compartments extending outward from a left and right side of the battery compartment, each of the four electric wheel motor controllers being in electrical communication with a regulated output terminal of the battery to receive electrical power therefrom and each of the four electric wheel motor controllers being in electrical communication with a corresponding electric motor that drives one of four wheels of the vehicle; and
a rotatable steering column extending upward from the front suspension assembly, an upper portion of the steering column having a plurality of operational controls positioned thereon and being positioned above the standing area, while a lower portion of the steering column connects to two separate front wheels by tie rods connected to an axially mounted tab that rotates/pivots with the steering column to cause the cooperative pivotal movement of the two separate front wheels in a substantially parallel orientation.

2. An all-wheel drive all-terrain vehicle, comprising:
a substantially rigid frame member that is elongated and includes a centrally located battery compartment positioned between two outer frame rails and a central standing area for a rider positioned above the battery compartment and between and above the outer frame rails, and an extended standing surface on each side of the vehicle extending outward from the central standing surface, the extended standing surface extending outward on each side of the vehicle to a location that is outward of an inside surface of tires of the vehicle and inward of an outside surface of the tires of the vehicle;
an independent rear suspension positioned at a first elongated end of the frame, the independent rear suspension configured to independently support and allow vertical suspension travel to two separate and independently movable rear wheels;
a front suspension assembly positioned at a second elongated end of the frame that is opposite the first end of the frame, the front suspension assembly configured to independently support and allow independent vertical suspension travel to two separate front wheels;
an electric motor positioned in each of the front two wheels and each of the rear two wheels and configured to provide motive force thereto;
a battery positioned in the battery compartment;
a front wheel electric controller positioned in the battery compartment and in electrical communication with the battery to receive electrical power therefrom and in electrical communication with the two independent electric motors positioned in the front two wheels and configured to selectively provide electrical power thereto; and
a separate rear wheel electric controller positioned in the battery compartment and in electrical communication with the battery to receive electrical power therefrom and in electrical communication with the two independent electric motors positioned in the rear two wheels and configured to selectively provide electrical power thereto.

3. The all-wheel drive all-terrain vehicle of claim 2, wherein:
the front wheel electric controller further comprises two separate controllers, a first front wheel controller exclusively powering a first front wheel and a second front wheel controller exclusively powering a second front wheel; and
the rear wheel electric controller further comprises two separate controllers, a first rear wheel controller exclusively powering a first rear wheel and a second rear wheel controller exclusively powering a second rear wheel.

4. The all-wheel drive all-terrain vehicle of claim 3, wherein the battery includes four independently regulated power outputs, each of the power outputs being connected on an individual wheel controller, and a battery management system (BMS) of the battery that operates to independently and separately control the electrical power applied to each of the four power outputs.

5. The all-wheel drive all-terrain vehicle of claim 2, wherein the front wheel electric controller is selectively activated by the plurality of operational controls to selectively change operation of the vehicle between all-wheel drive (all four wheels being electrically driven) and two-wheel drive (only the rear wheels being electrically driven), the font electric controller being selectively activated by a rider activating an electrical control switch.

6. The all-wheel drive all-terrain vehicle of claim 4, wherein the first front wheel controller and the second front wheel controller are selectively activated by the plurality of operational controls to selectively change operation of the vehicle between all-wheel drive (all four wheels being electrically driven) and two-wheel drive (only the rear wheels being electrically driven), the font electric controllers being selectively activated by a rider activating an electrical control switch.

7. The all-wheel drive all-terrain vehicle of claim 2, wherein the front wheel electric controller monitors current being applied by the rear wheel electric controller and adjusts an electrical current applied to the electric motors positioned in the front two wheels when a wheel slip is detected at the rear two wheels through a difference in current being applied by the rear wheel electric controller.

8. The all-wheel drive all-terrain vehicle of claim 2, wherein the front suspension assembly maintains a generally straight path of travel when a rider leans to one side or another of the vehicle, such that to turn the vehicle the rider must turn the steering column.

9. The all-wheel drive all-terrain vehicle of claim 2, wherein the rear suspension further comprises a twin A-arm configuration on each side (left and right) of the vehicle that are attached to the frame, the twin A-arms being pivotally attached to the frame and configured to move upward and downward, a distal end of the A-arms away from the frame attachment being connected to a wheel hub assembly such that as the wheel hub assembly moves up and down with terrain the wheel hub assembly and an associated tire remains substantially vertical in orientation as the A-arms translate up and down.

10. The all-wheel drive all-terrain vehicle of claim 2, wherein the front suspension further comprises a twin A-arm configuration on each side (left and right) of the vehicle that are attached to the frame, the twin A-arms being pivotally attached to the frame and configured to move upward and downward, a distal end of the A-arms away from the frame attachment being connected to a wheel hub assembly such that as the wheel hub assembly moves up and down with terrain the wheel hub assembly and an associated tire remains substantially vertical in orientation as the A-arms translate up and down.

11. The all-wheel drive all-terrain vehicle of claim 10, wherein the wheel hub assembly is pivotally mounted in a vertical axis, thus allowing the tires to remain substantially vertical while being pivoted through an arc about the vertical axis to effectuate a steering function.

12. An all-wheel drive all-terrain vehicle, comprising:
an elongated frame having a battery compartment and a rider standing surface positioned above the battery compartment and between to outer frame rails;
a rear suspension assembly positioned at a rear portion of the frame and configured to independently support and allow vertical suspension travel to two separate rear wheels while maintaining the two separate rear wheels in a substantially vertical orientation during the vertical suspension travel;
a front suspension assembly positioned at a front portion of the frame opposite the rear portion, the front suspension assembly configured to:
independently support and allow vertical suspension travel to two separate front wheels while maintaining the two separate front wheels in a substantially vertical orientation during the vertical suspension travel; and
allow cooperative pivotal movement of the two separate front wheels about a vertical axis for each wheel to enable steering functions, while maintaining the two separate front wheels in a substantially parallel orientation during the vertical suspension travel and maintaining the two front wheels in a substantially vertical orientation;
an independently operated electric motor positioned in each of the front two wheels and each of the rear two wheels and configured to provide motive force thereto;
a battery positioned in the battery compartment;
a front wheel electric controller positioned in the battery compartment and in electrical communication with the battery to receive electrical power therefrom and in electrical communication with the two independent electric motors positioned in the front two wheels and configured to selectively provide electrical power thereto;
a rear wheel electric controller positioned in the battery compartment and in electrical communication with the battery to receive electrical power therefrom and in electrical communication with the two independent electric motors positioned in the rear two wheels and configured to selectively provide electrical power thereto; and
a rotatable steering column extending upward from the front suspension assembly, an upper portion of the steering column having a plurality of operational controls positioned thereon and being positioned above the standing area, while a lower portion of the steering column connects to the two separate front wheels by tie rods connected to an axially mounted tab that rotates/pivots with the steering column to cause the cooperative pivotal movement of the two separate front wheels in a substantially parallel orientation.

13. The all-wheel drive all-terrain vehicle of claim 12, further comprising a bottom portion of the rotatable steering column being positioned near the front suspension assembly and having the axially mounted tab extending therefrom, a terminating end of the tab that is distal the steering column attaching to the tie rods that connect the tab of the steering column to pivotal hub assemblies to allow the steering column to change a direction of the hub assemblies.

14. The all-wheel drive all-terrain vehicle of claim 12, wherein:
the front wheel electric controller further comprises two separate controllers, a first front wheel controller exclusively powering a first front wheel and a second front wheel controller exclusively powering a second front wheel; and
the rear wheel electric controller further comprises two separate controllers, a first rear wheel controller exclusively powering a first rear wheel and a second rear wheel controller exclusively powering a second rear wheel.

15. The all-wheel drive all-terrain vehicle of claim 12, wherein the front wheel electric controller is selectively activated by a switch that is part of the plurality of operational controls, the switch operating to engage or turn on the front wheel electric controller to selectively change operation of the vehicle between all-wheel drive (all four wheels being electrically driven) and two-wheel drive (only the rear wheels being electrically driven), and when the front wheel electric controller is not activated, the front wheels may be in a freewheel state where they rotate with minimal resistance.

16. The all-wheel drive all-terrain vehicle of claim 14, wherein each wheel electric controller monitors current being applied by the other three wheel electric controllers and adjusts an electrical current applied to its associated electric motor when a wheel slip or predetermined differential in current is detected at another electric wheel controller.

17. The all-wheel drive all-terrain vehicle of claim 12, wherein the front suspension assembly maintains a generally straight path of travel when a rider shifts weight to one side of the vehicle, such that to turn the vehicle the rider must turn the steering column.

18. The all-wheel drive all-terrain vehicle of claim 12, wherein the rear suspension further comprises a twin A-arm configuration on each side (left and right) of the vehicle that are attached to the frame, the twin A-arms being pivotally attached to the frame and configured to move upward and downward, a distal end of the A-arms away from the frame attachment being connected to a wheel hub assembly such that as the wheel hub assembly moves up and down with terrain as the wheel hub assembly and an associated tire remains substantially vertical in orientation as the A-arms translate up and down.

19. The all-wheel drive all-terrain vehicle of claim 12, wherein the front suspension further comprises a twin A-arm configuration on each side (left and right) of the vehicle that are attached to the frame, the twin A-arms being pivotally attached to the frame and configured to move upward and downward, a distal end of the A-arms away from the frame attachment being connected to a wheel hub assembly such that as the wheel hub assembly moves up and down with terrain as the wheel hub assembly and an associated tire remains substantially vertical in orientation as the A-arms translate up and down.

20. The all-wheel drive all-terrain vehicle of claim 12, further comprising an operational mode where left side tires of the vehicle are caused to rotate in a first direction and right tires of the vehicle are cause to rotate in a second direction that is opposite the first direction, the cooperative wheel rotations in the first and second direction causing the vehicle to rotate on a vertical axis through the standing surface.
